(19) United States
(12) Patent Application Publication
(10) Pub. No.: US 2003/0170082 A1
(43) Pub. Date: Sep. 11, 2003

(54) Multiple-port drill plate and method for debris containment

(75) Inventors: John Garcia, Florence, CO (US); Matthew Roy Colver, Anaheim, CA (US); Richard M. Braeutigam JR., Alpine, CA (US); Robert D. Alfeld JR., Huntington Beach, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company, Seattle, WA

(21) Appl. No.: 10/094,582

(22) Filed: Mar. 8, 2002

(51) Int. Cl. B23B 35/00; B23B 47/34

(52) U.S. Cl. 408/1 R; 408/67; 408/115 R; 408/76

(57) ABSTRACT

A drill plate of the present invention includes a concave body and a vacuum manifold. The concave body defines a plurality of drill ports which act as a drill guides to ensure accurate drill hole placement. The concave body collects, and the vacuum manifold removes, debris from the drilling process. Individual magnetic seals cover each of the drill ports to prevent the escape of debris from the concavity. The drill plate further includes a plurality of tooling pins that allow the drill plate to be affixed to the structure being drilled to improve the accuracy of hole placement and for “hands free” operation. The tooling pins allow the drill plate to be used with composite structures that are held together by hard tooling, such as aluminum parts.

### FIELD OF THE INVENTION

The present invention relates to the field of cooling and dust containment during operation of cutting devices, and more specifically, to containment of debris that is generated during the operation of a drill to drill holes in large composite parts.

### BACKGROUND OF THE INVENTION

Cutting and drilling systems commonly generate large amounts of chips, dust and other debris. Open cutting and drilling systems require an additional worker, or workers, to manually vacuum debris while another worker cuts or drills the work piece with the cutting or drilling tool. The use of additional workers slows the cutting or drilling process and results in increased costs. In addition, the air pollutants generated by the process are not thoroughly controlled and removed by the use of a manual vacuum.

Debris extraction systems have been developed that extract debris from a work piece during drilling using an external vacuum. For instance, U.S. Pat. No. 5,033,917 to McGlasson et al. includes a nosepiece 16 assembly that fits over the end of a drill and defines a vacuum chamber. The bit of the drill extends through a bushing 12 mounted in the nosepiece. The top side of the bushing bounds the vacuum chamber. During operation, the bushing and drill bit are inserted through a lock-on bushing 18 and a drill plate 20 for accurate positioning of the drill. The chuck of the drill locks onto the lock-on bushing 18 to further maintain the positioning of the drill. Debris is drawn up through the bushing by the flutes of the drill bit and into the vacuum chamber. Vacuum supplied through a vacuum port 22 in the vacuum chamber draws the debris out of the chamber for disposal. However, debris can clog the relatively narrow bushing, causing the bushing to gall and overheat. Dust and debris can also accumulate in the vacuum chamber which increases temperature and clogs the chip extraction system. Such problems may reduce the life of carbide drill bits used on composite structures to the drilling of 10 to 30 holes before the bit must be discarded.

U.S. Pat. No. 4,662,802 discloses an alternative approach using a cupshaped member 9. The cup-shaped member includes a rim 23, a drill bit hole 27 and a suction attachment 15. During drilling, the cup shaped member is sealingly engaged to the surface of a workpiece and a drill bit is extended through the drill bit hole and onto the surface. Debris from the drill is captured in the cup shaped member and evacuated by vacuum supplied through the suction attachment. The size of the cup overcomes some of the problems of overheating and clogging encountered in other conventional designs. However, the cup shaped member is difficult to use with drill plates that accurately position drills because the drill plate interferes with the seal between rim of the cup-shaped member and the workpiece surface.

Composite materials, especially those used in the aerospace industry, pose a particular challenge for drilling and cutting systems. Drilling or cutting of the composites results in a large amount of particulate debris, including small debris in the form of dust. In addition, the placement and geometry of holes and cuts in aerospace structures must adhere to tight tolerances to enable proper assembly. Assemblies of composite parts frequently include tooling to join the composite parts that interferes with the use of conventional dust collection and drilling systems.

Therefore, it would be advantageous to have a drilling and debris containment system that is resistant to clogging and overheating. In addition, it would be advantageous to have a drilling and debris containment system that allows for the accurate drilling of holes. It would also be advantageous to avoid clogging and overheating of drill bits so as to extend the useful life of each drill bit. It would be further advantageous to have a drilling system that can be used with composites, particularly composites that include tooling and other detailing.

### SUMMARY OF THE INVENTION

The present invention addresses the above needs and achieves other advantages by providing a drill plate that includes a concave body for collecting, and a vacuum manifold for removing, debris from the drilling process. The drill plate includes a plurality of drill ports defined by the concave body which act as a drill guide to ensure accurate drill hole placement. The drill plate further includes a plurality of tooling pins that allow the drill plate to be fixed to the structure being drilled for accurate hole placement and for “hands free” operation. The tooling pins allow the drill plate to be used with composite structures that are held together by hard tooling, such as aluminum parts.

In one embodiment, the present invention includes a drill plate or bar connected to a vacuum pressure supply for collecting and removing debris resulting from the use of a drill and drill bit to drill holes into a structure. The drill plate includes a body and three vacuum outlets. The body defines a concavity and a plurality of drill ports. Each of the drill ports extend through the body and into the concavity. The drill ports are configured to receive and guide the drill bit of the drill. The body further includes an interface edge that extends about the perimeter or periphery of the concavity. The interface edge of the body is configured to contact the surface of the structure when the drill plate is placed against the structure. The three vacuum outlets of the drill plate are in fluid communication with both the concavity and the vacuum supply, providing a conduit therebetween. The concavity captures the debris generated during drilling, the interface edge seals the concavity against leakage of the debris and the debris is drawn out of the concavity and through the vacuum outlets by the vacuum supply.

In another aspect, the body further includes a plurality of bushings wherein each bushing defines one of the drill ports. Drill port seals can be used to seal the drill ports against escaping debris and can be moved away from the drill ports to allow receipt of the drill bit. Preferably, the drill port seal is constructed of a flexible magnetic material. In this embodiment, the drill plate further comprises a magnetically attractive material adjacent to each of the drill ports. In yet another aspect, the drill ports are arranged in an array of rows and columns that correspond to desired hole locations in the structure being drilled.

In another embodiment, the body of the drill plate defines an inlet port that allows air to be drawn into the concavity by the vacuum pressure supplied through the vacuum manifold. The interface edge is preferably lined with a gasket of foam rubber to prevent the escape of debris.

In yet another aspect, the drill plate includes a set of tooling pins that are arranged to correspond with preexisting holes in the structure. The tooling pins are inserted into the preexisting holes so as to position the drill plate on the structure. Positioning of the drill plate aligns the drill ports to act as guides and ensure accurate hole placement. The drill plate is easily lifted through the use of a pair of handles. Preferably, the drill plate is constructed mostly of a composite material that is easier to lift and position on the structure due to its light weight.

The present invention has several advantages. A single drill plate is used to contain dust and debris while allowing the drilling of multiple holes without repositioning of the drill plate. In addition, the handles and tooling pins of the drill plate, along with its lightweight construction, allow the drill plate to be easily positioned and secured with subsequent “hands free” operation. The vacuum system removes dust and debris which avoids clogging of the drilling system and associated higher operating temperatures, thereby extending the life of each drill bit, bushing and drill. The compressibility of the seal or gasket allows the interface to seat against the drilling surface and conform to minor surface irregularities and imperfections. Further, the drill port seals prevent the escape of debris from the concavity and their magnetic properties make them easy to remove and replace.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a drill plate or bar of one embodiment of the present invention;

FIG. 2 is a cross-sectional view of the drill plate of FIG. 1 with a drill port of the drill plate receiving a drill bit of a drill;

FIG. 3 is a cross-sectional view of the drill plate of FIG. 1 showing a vacuum outlet for removing debris from the drilling process; and

FIG. 4 is a plan view of a drill, or cutting tool, that is supplied shop air to assist in cooling and debris removal from the drill plate of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

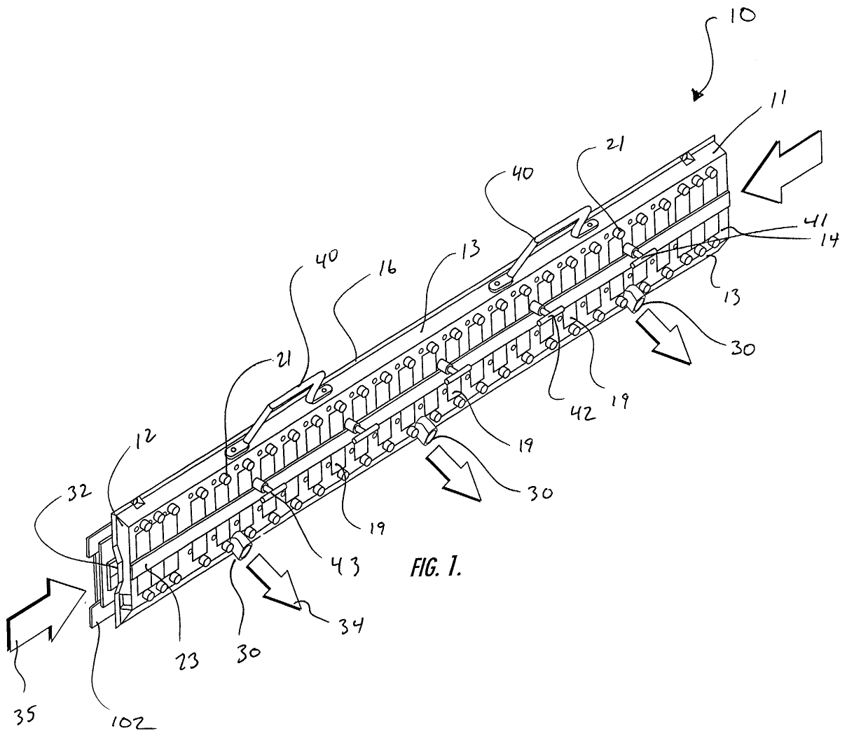

A drilling plate or bar 10 of the containment and drilling system of the present invention is shown in FIGS. 1-3. The drilling bar includes a concave body 11 for ensuring accurate drill hole placement and to capture dust and debris generated during the drilling process. The drilling bar 10 further includes a set of three vacuum ports 30 that are part of a vacuum manifold for removing the dust and debris captured by the concave body. The drilling bar 10 also includes an attachment system to allow the secure and accurate attachment of the drilling bar to a work piece, such as a composite structure 100.

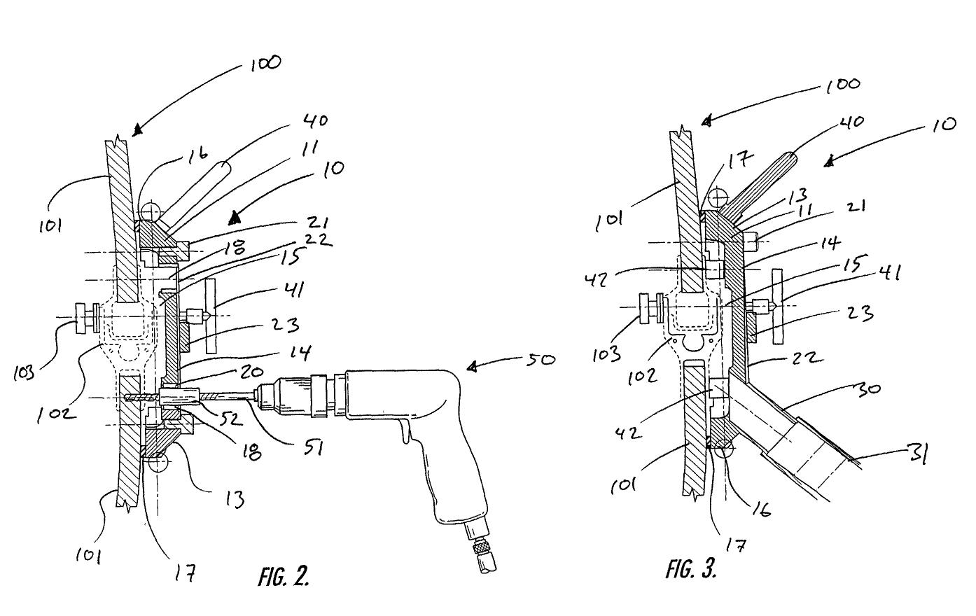

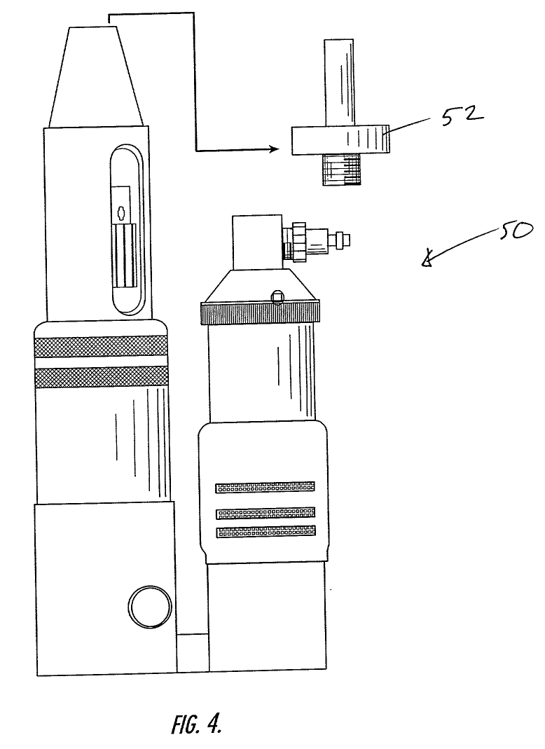

The body 11 has an elongated, rectangular shape that is defined by a pair of end walls 12, a pair of side walls 13 and a top wall 14. The pair of end walls 12 are in a parallel, spaced relationship with respect to each other. The pair of side walls are also in a parallel, spaced relationship with respect to each other. The end walls 12 and side walls 13 are connected at their ends so as to form the rectangular shape, as best shown in FIG. 1. Although the rectangular shape is preferred, the body 11 may also have other shapes, such as a range of different polygons, circles, ovals or a non-polygonal, irregular shape. The top wall 14 connects the top edges of the walls 13, 14 to form a concavity 15, as shown in FIGS. 2 and 3. Attached to the bottom edges of the walls 12, 13 is a lip 16 that is placed against the composite structure 100 during drilling to form a fully or partially sealed interface. A seal or gasket 17 is preferably mounted around the bottom lip of the walls 13, 14 to aid in sealing the interface between the drilling bar 10 and the composite structure 100 or other work piece. The gasket 17 is preferably constructed of a foam rubber material with a nylon surface for increased durability. Rubber, silicone or other soft and flexible materials could be used to construct the gasket.

The body 11 of the drilling bar 10 includes a plurality of drill ports 18 for receiving and guiding a drill bit 51 of a drill 50, as shown in FIG. 2. The drill ports 18 are arranged in a pair of rows along the length of the top wall 14. The positioning of the drill ports 18 corresponds to the desired positioning of the drill holes on the composite structure 100. It should be noted that other arrangements of the drill ports could be employed depending upon the hole pattern desired, the number of holes desired, the size and weight of the drill plate, etc. Each of the drill ports 18 preferably includes a bushing 20 that is mounted in a hole of the drill port, wherein the hole through the bushing provides access to the concavity 15 through the top wall 14. Each busing 20 is toleranced to receive and accurately guide the drill bit 51, or a drill bit bushing 52 that accompanies the drill, as shown in FIG. 4. Alternatively, the drill ports 18 may not include a bushing and be toleranced to receive the drill bit bushing 52, or just the drill bit 51 itself.

The drilling bar 10 preferably includes an array of locking features 21 wherein each locking feature is adjacent to a respective one of the drill ports 18, as shown in FIG. 1. During drilling, the locking features 21 act as a stop to keep the chuck of the drill from rotating, thereby reducing the force transmitted to the hands of the worker. Reducing the force exerted by the worker reduces subsequent worker fatigue, as is known in the art.

The relatively close fit of the drill bit 51 and drill bit bushing 52 through each of the drill ports 18 blocks the escape of dust and debris from the concavity 15. A plurality of port seals 19 are each arranged to cover a respective one of the drill ports 18 and seal those ports not in use during drilling to prevent the escape of debris. Preferably, the port seals 19 are constructed of a thin, flexible magnetic sheet that is magnetically attracted to the material in proximity to the drill ports 18. The body 11 of the drilling bar 10 is preferably constructed of a lightweight synthetic material, such as plastic or fiberglass, or more preferably, carbon fiber. Use of synthetic materials in the construction of the drilling bar 10 minimizes the weight of the drilling bar. However, synthetic materials are not attractive to the magnetic port seals 19.

In the present embodiment, as shown in FIGS. 2 and 3, the drilling bar 10 includes a thin metal plate 22 that attracts the magnetic seal. The thin metal plate 22 is held to the body 11 by a longitudinal member 23 attached to the center, and extending along the length of, the top wall 14. The metal plate is magnetically attractive (preferably steel) and surrounds the entrance to each of the drill ports 18. In one embodiment, the metal plate includes a center strip and rectangular portions extending above and below the center strip. The center strip is preferably the same general size and shape as the longitudinal member 23. The rectangular portions preferably correspond to the geometry and position of the magnetic seals 19, and each define an opening allowing access to a respective one of the drill ports 18. The thinness and geometry of the metal plate 22, as opposed to a mostly metal body 11, reduces the weight added to the drilling bar 10. The entire drilling bar 10 could be metal, however. The use of the flexible magnetic material also has the advantage of adding little weight to the drilling bar 10 and is easily removed and replaced while still providing a firm seal against the escape of dust and debris.

It should be noted that the size, shape and material construction of the seals may be varied to suit the size and shape of the drill ports, and the materials used to construct the body 11. For instance, in another embodiment the seals are constructed of a thin, circular rotating metal plate (not shown) that swings on a pin to block a respective one of the drill ports. A rubber gasket or seal is affixed to the underside of the metal plate to ensure a relatively leak-free seal against the body when the metal plate is rotated to cover the drill port.

A pair of inlets 32, the concavity 15 and the nozzles 31 form a vacuum manifold system through which air is drawn to remove debris generated by drilling, as shown in FIGS. 1-3. The three vacuum outlets 30 are each attached to one of three conduits 31. The three conduits are, in turn, connected to a vacuum pressure supply (not shown) which is preferably a high-efficiency particulate air (HEPA), filtered vacuum. The pair of inlets 32 are positioned at the ends of the body 11 and are defined by the bottom lip 16 of the end walls 12. During operation, air is drawn by the vacuum pressure through the inlets 32 in the direction of arrows 34 and into the concavity 15. While in the concavity, the air travels along the length of the body 11, collecting dust and debris from drilling, and out through the three outlets 30 in the direction of arrows 35. The vacuum manifold system can be modified, as desired, to draw larger or smaller amounts of debris at different rates. For example, additional outlets 30 and conduits 31 may be used depending upon the dimensions of the drilling bar 10, the desired rate of evacuation, the amount of dust and debris created by drilling and other factors. However, in the present embodiment a single outlet 30 and conduit 31 combination has been shown to evacuate about 90% of all dust and debris, while three ports and nozzles have been shown to evacuate greater than 90%, and even 99%, of all dust and debris.

The drilling bar 10 has an attachment system that comprises a pair of handles 40 and a set of tooling pins 41 that allow for easy and accurate placement of the drilling bar with subsequent “hands-free” operation, as shown in FIG. 1. The pair of handles are fixed to the top one of the side walls 13, along the length of the drilling bar. The pair of handles 40 allow the drilling bar 40 to be easily lifted and placed on the composite structure 100. Preferably, a large part of the drilling bar 10 is constructed of synthetic materials that make lifting and placement of the drilling bar an easy task. The placement and number of handles can be varied as desired, but two handles are preferred to allow the drilling bar to be lifted using two hands and also to allow the bar to be oriented by raising or lowering each end.

Five of the tooling pins 41 are placed length-wise along the center of the top wall 14 in positions corresponding to pre-drilled holes in the composite structure 100, as shown in FIG. 1. The tooling pins include handles attached at the top of threaded rods or bolts that can be hand-tightened into holes in the composite structure. The threaded rod of the tooling pin passes through a threaded hole in the top wall 14 and extends into the concavity 15. The number, length and size of the tooling pins depend upon such factors as the size and weight of the drilling bar 10 and the number, or spacing, of the holes in the composite structure 100. Further included in the attachment system is a set of pads 42 that protect the composite structure against damage during placement of the drilling bar 10. Preferably, the pads are constructed of a flexible material, such as PTFE (TEFLON) or rubber, that is compressible and wear resistant.

Although a range of work pieces can be drilled using the drilling system of the present invention, the drilling system is preferred for composite structures. For example, the composite structure 100 shown in the Figures is a fairing for releasably protecting a payload of a rocket. The fairing includes several composite panels 101 that are joined together by aluminum tooling or parts 102 that are attached along the seam of the panels and are held together by a bolt 103. The overall shape of the body 11 of the drilling bar 10 is configured to provide clearance for the aluminum tooling 102, as shown in FIGS. 2 and 3. The tooling pins 41 are positioned to correspond to holes in the aluminum tooling 102, which ensures accurate placement of the drilling bar. Accurate placement of the drilling bar, in turn, ensures accurate placement of the drill bit 51 and the holes drilled using the drill bit. Preferably, the drill holes are drilled to 0.215-0.220 inches in diameter, followed by drilling to 0.257-0.262 inches in diameter.

Various drills can be employed with the drilling system of the present invention. One particularly effective type of drill, shown in FIG. 4, is a positive feed drill motor (Quackenbush Model 15QDB-S125, Cooper Industries, Houston, Tex.) that uses pressurized “shop” air to run the motor and to help pressurize the drill plate 10. Preferably, the shop air supplied at 80 to 100 psi of pressure. The motor is an in-line, piggy-back model with a stroke of 1.250 inches, a spindle speed of 2000 RPM and a feed rate of 0.003 inches per revolution. The shop air is fed through the motor, through the flutes of the drill bit and into the concavity 15 to be routed through the manifold system with the debris from drilling. Beyond the contribution to debris removal, the additional airflow contributes to cooling of the cutting tool. The positive feed drill motor also includes locked bushings 52 which complement the drill ports 18 and can be inserted therein. For a composite fairing, the preferred type of drill bits are diamond tip cutters which are carbide cutters with diamond inserts that provide 1000 quality holes without cutter replacement.

The term drilling as used herein is defined to include a range of cutting operations and should not be construed as limited to rotary drilling using a fluted drill bit. In addition, the term drill is used to generically refer to the motors of various cutting tools that cause rotation, or other movement, of the cutting tool. The definition of debris is herein defined to include all manner of undesirable waste resulting from the drilling or cutting operation including, but not limited to, such things as chips, dust, and shavings and including debris of various compositions such as metal, synthetic and composite debris.

The drilling plate or bar 10 is employed by first grasping the handles 40 and positioning the drilling bar on the composite structure 100. The position of the drilling bar 10 is adjusted until the tooling pins 40 match preexisting holes in the aluminum tooling 102 and the gasket 17 seals over any irregularities on the surface of the work piece. The handles of the tooling pins 40 are grasped and tightened to secure the drilling bar 10 onto the composite structure 100 and compressing the gasket 17, leaving the operator's hands free for drilling. The conduits 31 are attached to their respective outlets 30, as shown in FIG. 3. The vacuum supply is turned on and air is drawn through the inlets 32, into the concavity 15 and out of the outlets 30.

The operator then selects one of the drill ports 18 corresponding to the desired location of a drill hole and peels back the seal 19 over the drill port. The drill bit 51 and drill bushing 52 are inserted into the bushing 20 defining the respective drill port. The drill 50 is switch on which advances the drill bit 51 into the composite structure 100, cutting a hole and creating debris, including dust. The debris is drawn away through the manifold system and into the conduits 31, as described above. The escape of debris from the other drill ports 18 is prevented by each seal 19. Once drilling of a first hole is complete, the drill bit and drill bushing 52 are removed from the respective one of the drill ports 18. The seal 19 is replaced on the drill port and a second drilling site is selected, the seal removed from the newly selected drill port and drilling is commenced. This process is repeated until desired, or until all of the drill ports 18 have been used to create corresponding holes in the composite structure 110.

The drill plate 10 of the present invention has several advantages. A single drill plate is used to contain dust and debris while allowing the drilling of multiple holes without repositioning of the drill plate. In addition, the handles 40 and tooling pins 41 of the drill plate 10, along with its lightweight construction, allow the drill plate to be easily positioned and secured with subsequent “hands free” operation. The vacuum system removes dust and debris which avoids clogging of the drilling system and associated higher operating temperatures, thereby extending the life of each drill bit, bushing and drill. The compressibility of the gasket 17 allows the interface to seat against the drilling surface and conform to minor surface irregularities and imperfections. Further, the drill port seals 19 prevent the escape of debris from the concavity 15 and their magnetic properties make them easy to remove and replace.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A drill plate connected to a vacuum pressure supply for collecting and removing debris resulting from use of a drill and drill bit to drill holes into a structure having a surface, said drill plate comprising:
a body defining a concavity and a plurality of drill ports, each of said plurality of drill ports extending through the body and into the concavity, said drill ports configured to receive and guide the drill bit of said drill;
said body further including an interface edge that extends at least partially about a periphery of the concavity, wherein the interface edge is configured to contact the surface of the structure when the drill plate is placed against the structure; and
at least one vacuum outlet in fluid communication with the concavity and with the vacuum supply;
wherein the concavity captures debris generated during drilling, the interface edge seals the concavity against leakage of the debris and said debris is drawn out of the concavity and through the vacuum outlet by the vacuum supply.

2. A drill plate of claim 1, wherein the body further includes a plurality of bushings, each bushing defining one of the drill ports.

3. A drill plate of claim 1, further comprising a plurality of drill port seals that seal the drill ports against escaping debris and that are movable away from the drill ports to allow receipt of the drill bit.

4. A drill plate of claim 3, wherein the drill port seal is constructed of a flexible magnetic material and said drill plate further comprises a magnetically attractive metal adjacent to each of the drill ports.

5. A drill plate of claim 1, wherein the plurality of drill ports are arranged in an array of rows and columns corresponding to desired hole locations on the structure.

6. A drill plate of claim 1, wherein the body has an elongate shape and the drill ports are arranged in at least one row along the length of the body.

7. A drill plate of claim 1, wherein the body further defines at least one inlet port that allows air to be drawn into the concavity by the vacuum pressure supplied through the vacuum outlet.

8. A drill plate of claim 1, further comprising at least one tooling pin that connects the drill plate to the surface of the structure.

9. A drill plate of claim 8, wherein the tooling pins are arranged to correspond with preexisting holes in the structure.

10. A drill plate of claim 1, further comprising at least one handle for holding the drill plate to the surface of the structure.

11. A drill plate of claim 1, wherein said interface edge includes a gasket.

12. A drill plate of claim 11, wherein the gasket is constructed of a foam rubber material.

13. A drill plate of claim 1, wherein three vacuum outlets are spaced along the body.

14. A drill plate of claim 1, wherein the body is primarily constructed of a lightweight composite material.

15. A method of collecting debris resulting from operation of a drill and drill bit while drilling holes into a structure having a surface, said method comprising:
positioning a drill plate against the structure so that a concavity defined by the drill plate covers desired locations of the holes;
sealing an interface edge of the body against the surface of the structure, wherein the interface edge extends at least partially about a periphery of the concavity;
connecting a vacuum supply conduit to a vacuum outlet and establishing fluid communication between the vacuum supply and the concavity;
inserting the drill bit through one of a plurality of drill ports defined by the body and drilling a first hole;
capturing in the concavity, and evacuating out of the vacuum outlet, debris generated by drilling;
removing the drill bit from the drill port; and
inserting the drill bit through a second one of the plurality of drill ports and drilling a second hole.

16. A method of collecting debris of claim 1, further comprising removing a seal from the first one of the drill ports before inserting the drill bit and replacing the seal after removing the drill bit from the drill port.

17. A method of collecting debris of claim 1, further comprising inserting tooling pins into preexisting holes defined by the structure and tightening the tooling pins after positioning the drill plate.

18. A method of collecting debris of claim 1, further comprising drawing air through an inlet port defined by the drilling plate and into the concavity while evacuating debris.

19. A method of collecting debris of claim 1, wherein said sealing the interface edge includes positioning a gasket on the surface of the structure.
